(19) United States
(12) Patent Application Publication
(10) Pub. No.: US 2025/0369526 A1
(43) Pub. Date: Dec. 4, 2025

(54) VENTILATION STRUCTURE OF REFRIGERANT RECOVERY MACHINE

(71) Applicant: ZHEJIANG VALUE MECHANICAL & ELECTRICAL PRODUCTS CO., LTD., Taizhou, Zhejiang (CN)

(72) Inventor: Yourong JIANG, Taizhou, Zhejiang (CN)

(21) Appl. No.: 18/863,284

(22) PCT Filed: Jan. 4, 2024
(86) PCT No.: PCT/CN2024/070543

§ 371 Date: Aug. 21, 2025

(30) Foreign Application Priority Data
Nov. 13, 2023 (CN) 2023230495559

(51) Int. Cl. F16K 15/06

(52) U.S. Cl. CPC F16K 15/065; F16K 2200/303

(57) ABSTRACT

The present utility model belongs to the technical field of refrigerant recovery, and in particular relates to a ventilation structure of a refrigerant recovery machine. Aiming at the lack of protection against the impact of a liquid refrigerant on a spring of an intake valve and/or exhaust valve of the existing refrigerant recovery machine, the present utility model adopts the following technical solution: a ventilation structure of a refrigerant recovery machine, including: a valve seat provided with an air hole; a valve core axially movable relative to the air hole; a compression spring mounted on the valve core: and a protection assembly provided on the valve seat, where the protection assembly is provided with an annular wall, the annular wall surrounds the compression spring, the compression spring is located at a distance from the valve seat, and a region of the protection assembly between the compression spring and the valve seat forms a radial ventilation passage. The ventilation structure of the refrigerant recovery machine in the present utility model has the beneficial effect that the impact of the liquid refrigerant in the radial airflow on the compression spring is reduced or avoided.

### TECHNICAL FIELD

The present utility model belongs to the technical field of refrigerant recovery, and in particular relates to a ventilation structure of a refrigerant recovery machine.

### BACKGROUND

Chinese utility model patent with granted publication No. CN21742205U discloses an intake valve of a refrigerant recovery machine, including: a valve seat provided with an intake hole; a valve core axially movable in the intake hole, the end of the valve core away from the intake hole being provided with a mounting groove; a first elastic member mounted in the mounting groove; a second elastic member abutting against the first elastic member; a flat washer abutting against the circular member; a compression springs respectively abutting against the valve seat and the flat washer. In this utility model, by adding the elastic members, the elastic members absorb some energy through deformation, so that the first elastic member is subjected to less force and is not easily damaged or loosened.

However, there are still some problems with the solution of the abovementioned utility model: 1) the liquid refrigerant in the airflow will cause radial impact on the spring, causing it to be deflected and increasing the risk of spring fracture in the case of reciprocating motion at this moment; 2.) since the stroke of the spring is not limited, the greater the load, the longer the stroke of the spring, which easily leads to insufficient fatigue strength and results in spring fracture; 3) since a conical spring is adopted, in the compression process, as the pitch decreases, the intake volume at the intake of the valve seat decreases; moreover, the gap between the conical spring and the valve core is large, and the radial deflection of the conical spring is large; 4) after the spring is fractured, the movement of the valve core loses the guiding effect of the spring; due to the long stroke, the valve core will be deflected, and the valve core rod will collide with the valve seat; after multiple impacts, the valve core will be deformed, resulting in the failure of the entire ventilation structure and ultimately causing compressor jamming.

At the same time, the exhaust valve of the refrigerant recovery machine also has the following similar problems: 1) the liquid refrigerant can cause radial impact to the spring; 2) it fails to guide the valve core, the guiding effect is poor, or it is difficult to ensure the guiding effect; 3) after the spring is fractured, the wire of the fractured spring enters the internal passage, thus affecting the service life of the compressor.

### SUMMARY

Aiming at the lack of protection against the impact of a liquid refrigerant on a spring of an intake valve and/or exhaust valve of the existing refrigerant recovery machine, the present utility model provides a ventilation structure of a refrigerant recovery machine, so as to protect the spring, avoid or reduce the impact on the spring from the liquid refrigerant, and avoid or reduce spring failure and the adverse effect caused by spring failure; further, guide the spring, reduce or avoid spring deflection, limit the stoke of the spring and improve the service life of the spring.

In order to achieve the purpose, the present utility model adopts the following technical solution: a ventilation structure of a refrigerant recovery machine, including:
a valve seat provided with an air hole;
a valve core axially movable relative to the air hole;
a compression spring mounted on the valve core: and
a protection assembly provided on the valve seat,
wherein the protection assembly is provided with an annular wall, the annular wall surrounds the compression spring, the compression spring is located at a distance from the valve seat, and a region of the protection assembly between the compression spring and the valve seat forms a radial ventilation passage.

The ventilation structure of the refrigerant recovery machine in the present utility model is provided with the protection assembly, the protection assembly is provided with the annular wall, the annular wall surrounds the compression spring, and the annular wall can reduce or avoid the impact of the liquid refrigerant in the axial airflow on the compression spring; the compression spring is located at a certain distance from the valve seat, the region of the protection assembly between the compression spring and the valve seat forms the radial ventilation passage, all or part of the liquid refrigerant will follow the airflow along the outer wall of the annular wall to reach the ventilation passage, and then pass through the ventilation passage to reach the air hole, thus avoiding or reducing the impact of the liquid refrigerant on the compression spring when passing through the compression spring.

As an improvement, the protection assembly is provided with a guide portion for guiding a central part of the valve core, and the compression spring is further away from the air hole than the guide portion.

As an improvement, the ventilation structure of the refrigerant recovery machine includes an intake structure, and the intake structure includes:
the valve seat provided with an intake hole;
an intake valve core axially movable relative to the intake hole;
an abutting assembly mounted at the end of the intake valve core away from the intake hole;
an intake protection assembly provided on the valve seat; and
an intake spring sleeving the intake valve core and respectively abutting against the intake protection assembly and the abutting assembly,
wherein the intake protection assembly is provided with an intake annular wall, the intake annular wall surrounds the intake spring, the intake spring is located at a distance from the valve seat, and a region of the intake protection assembly between the intake spring and the valve seat forms an intake passage.

As an improvement, projections of the abutting assembly and the intake protection assembly in an axial direction at least partially overlap to limit the compression degree of the intake spring;
the side of the abutting assembly facing to the valve seat is provided with a limiting groove, and one end of the intake spring is fit with the limiting groove.

As an improvement, the intake protection assembly is further formed with an inclined guide surface, a limiting portion, a supporting portion and an intake guide portion for guiding the intake valve core, the intake spring abuts against the supporting portion, and the limiting portion limits a radial direction of the intake spring;
a radial gap between the intake annular wall and the intake spring is smaller than a radial gap between the intake spring and the intake valve core;
an upper end of the intake annular wall radially extends outward to form a convex ring.

As an improvement, the intake protection assembly includes a bracket and a spring seat which are fixedly connected with each other, the bracket is mounted on the valve seat, the intake annular wall is formed on the spring seat, and the bracket is hollowed out to form the intake passage.

As an improvement, the bracket includes a first annular portion, a second annular portion, and a plurality of column portions between the two, the intake passage is formed between the plurality of column portions, an annular convex portion is formed at the intake hole of the valve seat, the first annular portion sleeves the annular convex portion, and the diameter of an outer circle formed by the plurality of column portions is smaller than that of the first annular portion to form a step;
the annular convex portion of the valve seat is further formed with an annular groove, and the height of the first annular portion is adapted to the depth of the annular groove.

As an improvement, a lower end of the spring seat forms the intake guide portion, the intake guide portion is inserted into the second annular portion, the intake guide portion is in clearance fit with the intake valve core, and the second annular portion supports the spring seat;
the intake spring is a cylindrical spring;
the abutting assembly includes a first elastic member, a second elastic member and a top ring, and the top ring is provided with the limiting groove.

As an improvement, the ventilation structure of the refrigerant recovery machine includes an exhaust structure, and the exhaust structure includes:
the valve seat provided with an exhaust hole;
an exhaust valve core axially movable relative to the exhaust hole;
an exhaust protection assembly provided on the valve seat and provided with an exhaust guide portion for guiding the exhaust valve core; and
an exhaust spring provided on the exhaust valve core and respectively abutting against the exhaust protection assembly and the exhaust valve core,
wherein the exhaust protection assembly is provided with an exhaust annular wall, the exhaust annular wall surrounds the exhaust spring, the exhaust spring is located at a distance from the valve seat, and a region of the exhaust protection assembly between the exhaust spring and the valve seat forms an exhaust passage.

As an improvement, the exhaust protection assembly includes an exhaust protection sleeve and a locating pin, the exhaust protection sleeve is fixed to the valve seat through the locating pin, and the end of the exhaust protection sleeve close to the exhaust hole is hollowed out to form the exhaust passage;
the exhaust protection sleeve is provided with a cylindrical portion, a reinforcement portion and an opening portion, one end of the exhaust spring abuts against the cylindrical portion, and the cylindrical portion forms the exhaust annular wall; the cylindrical portion is in clearance fit with the exhaust valve core.

The ventilation structure of the refrigerant recovery machine in the present utility model has the following beneficial effects: it is provided with the protection assembly, the protection assembly is provided with the annular wall, the annular wall surrounds the compression spring, and the annular wall reduces or avoids the impact of the liquid refrigerant in the axial airflow on the compression spring; the compression spring is located at a certain distance from the valve seat, the region of the protection assembly between the compression spring and the valve seat forms the radial ventilation passage, all or part of the liquid refrigerant will follow the airflow along the outer wall of the annular wall to reach the ventilation passage, and then pass through the ventilation passage to reach the air hole, thus avoiding or reducing the impact of the liquid refrigerant on the compression spring when passing through the compression spring.

### DESCRIPTION OF THE DRAWINGS

FIG. 1 illustrates a 3D schematic structural diagram of an intake structure of a ventilation structure of a refrigerant recovery machine according to embodiment 1 of the present utility model.

FIG. 2 illustrates a sectional view of an intake structure of a ventilation structure of a refrigerant recovery machine according to embodiment 1 of the present utility model.

FIG. 3 illustrates a structural exploded view of an intake structure of a ventilation structure of a refrigerant recovery machine according to embodiment 1 of the present utility model.

FIG. 4 illustrates a schematic structural diagram of a valve seat of an intake structure of a ventilation structure of a refrigerant recovery machine according to embodiment 1 of the present utility model.

FIG. 5 illustrates a schematic structural diagram of a valve core of an intake structure of a ventilation structure of a refrigerant recovery machine according to embodiment 1 of the present utility model.

FIG. 6 illustrates a schematic structural diagram of a bracket of a protection assembly of an intake structure of a ventilation structure of a refrigerant recovery machine according to embodiment 1 of the present utility model.

FIG. 7 and FIG. 8 illustrate schematic structural diagrams of a spring seat of a protection assembly of an intake structure of a ventilation structure of a refrigerant recovery machine according to embodiment 1 of the present utility model from different perspectives.

FIG. 9 illustrates a sectional view of an intake structure of a ventilation structure of a refrigerant recovery machine according to embodiment 1 of the present utility model (a cylinder head is further shown relative to FIG. 2).

FIG. 10 illustrates a 3D schematic structural diagram of an exhaust structure of a ventilation structure of a refrigerant recovery machine according to embodiment 2 of the present utility model.

FIG. 11 illustrates a sectional view of an exhaust structure of a ventilation structure of a refrigerant recovery machine according to embodiment 2 of the present utility model.

FIG. 12 illustrates a structural exploded view of an exhaust structure of a ventilation structure of a refrigerant recovery machine according to embodiment 1 of the present utility model.

FIG. 13 illustrates a schematic structural view of an exhaust protection sleeve of an exhaust structure of a ventilation structure of a refrigerant recovery machine according to embodiment 1 of the present utility model.

FIG. 14 illustrates a sectional view of an exhaust structure of a ventilation structure of a refrigerant recovery machine according to embodiment 1 of the present utility model (a cylinder head is further shown relative to FIG. 10).

Description of reference signs: 1—valve seat; 11—intake hole; 12—annular convex portion; 13—annular groove; 14—exhaust hole;
2—intake valve core;
3—first elastic member;
4—second elastic member;
5—top ring; 51—limiting groove;
6—intake protection assembly; 61—bracket; 611—first annular portion; 612—second annular portion; 613—column portion; 62—spring seat; 621—intake annular wall; 622—inclided guide surface; 623—limiting portion; 624—supporting portion; 625—intake guide portion; 626—convex ring;
7—intake spring;
2A—exhaust valve core;
6A—exhaust protection assembly; 63—exhaust protection sleeve; 631—cylindrical portion; 632—reinforcement portion; 633—opening portion; 64—locating pin;
7A—exhaust spring;
8—cylinder head

### DESCRIPTION OF THE EMBODIMENTS

The technical solutions of the embodiments of the present utility model will be explained and described below, but the following embodiments are only preferred embodiments instead of all embodiments of the present utility model. Based on the embodiments described, any other embodiments obtained by those skilled in the art without contributing any inventive labor still fall within the scope of protection of the present utility model.

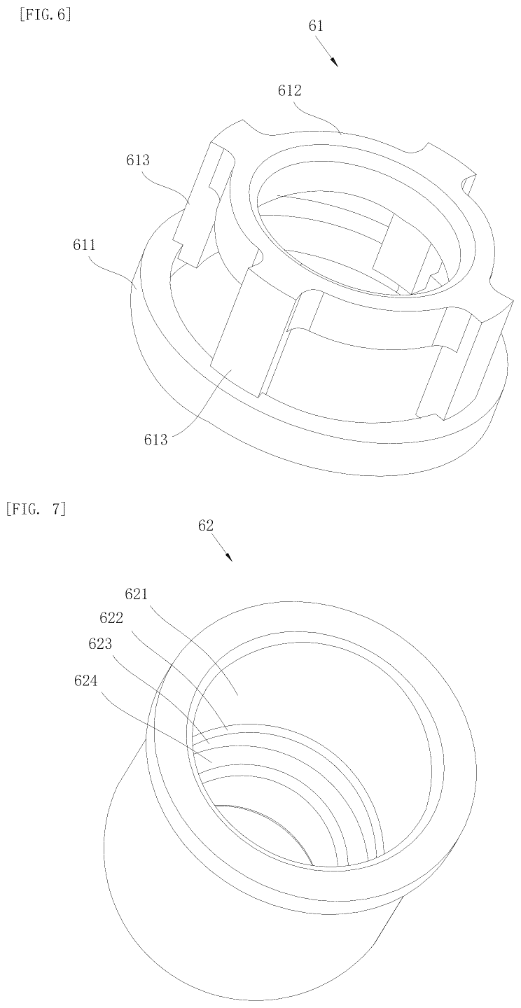

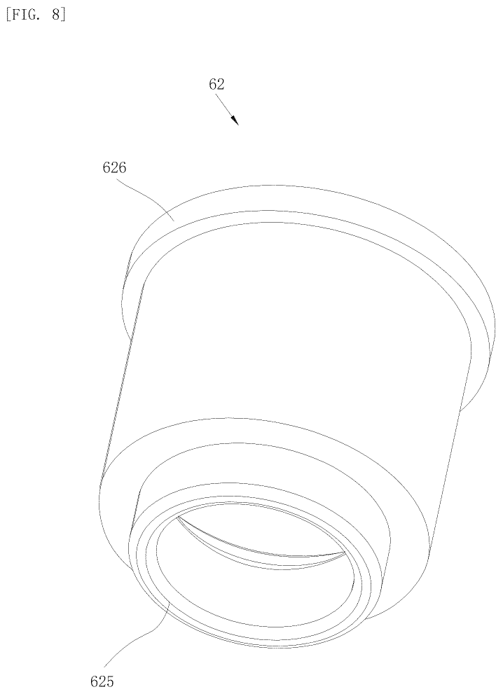

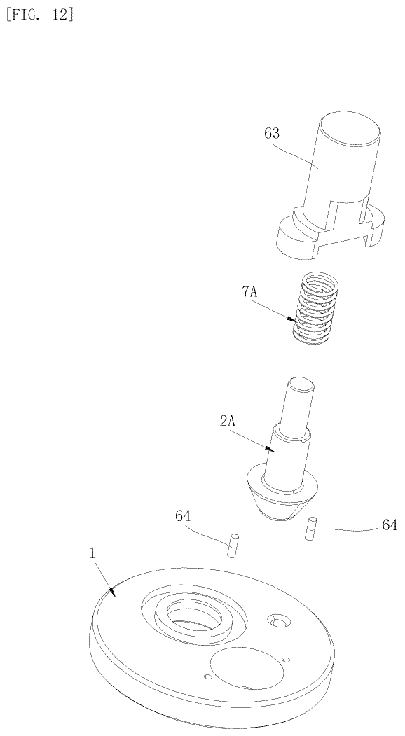

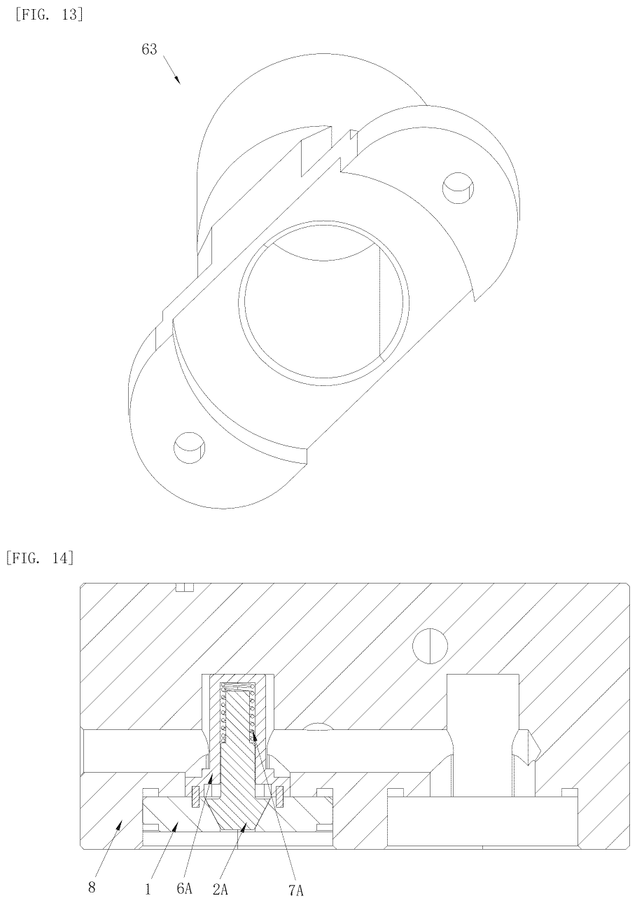

Referring to FIG. 1 to FIG. 14, a ventilation structure of a refrigerant recovery machine includes:
a valve seat provided with an air hole;
a valve core axially movable relative to the air hole;
a compression spring sleeving the valve core: and
a protection assembly provided on the valve seat,
wherein the protection assembly is provided with a guide portion for guiding a central part of the valve core, and the compression spring is further away from the air hole than the guide portion.

In the ventilation structure of the refrigerant recovery machine in the present utility model, the protection assembly is provided on the valve seat, the protection assembly is provided with the guide portion for guiding the valve core, and the protection assembly guides the central part of the valve core, thus preventing the valve core from being deflected; the protection assembly is provided on the valve seat and the air hole is also provided in the valve seat, thus more easily ensuring the coaxiality of the protection assembly and the valve core, and guaranteeing the guiding effect.

### Embodiment 1

Referring to FIG. 1 to FIG. 4, a ventilation structure of a refrigerant recovery machine according to embodiment 1 of the present utility model includes an inlet structure and an exhaust structure.

Referring to FIG. 1 to FIG. 9, the intake structure of the ventilation structure of the refrigerant recovery machine according to embodiment 1 of the present utility model includes:
a valve seat 1 provided with an intake hole 11;
an intake valve core 2 axially movable relative to the intake hole 11, the end of the intake valve core 2 away from the valve seat 1 being provided with a mounting groove;
a first elastic member 3 mounted in the mounting groove;
a top ring 5 sleeving the intake valve core 2 and closer to the valve seat 1 than the first elastic member 3;
a second elastic member 4 located between the first elastic member 3 and the top ring 5;
an intake protection assembly 6 provided on the valve seat 1; and
an intake spring 7 sleeving the intake valve core 2 and respectively abutting against the intake protection assembly 6 and the top ring,
wherein the intake protection assembly 6 is provided with a guide portion for guiding the intake valve core 2;
the intake protection assembly 6 is provided with an intake annular wall 621, and the intake annular wall 621 surrounds the intake spring 7.

In this embodiment, the intake annular ring 621 only surrounds a local part of the intake spring 7.

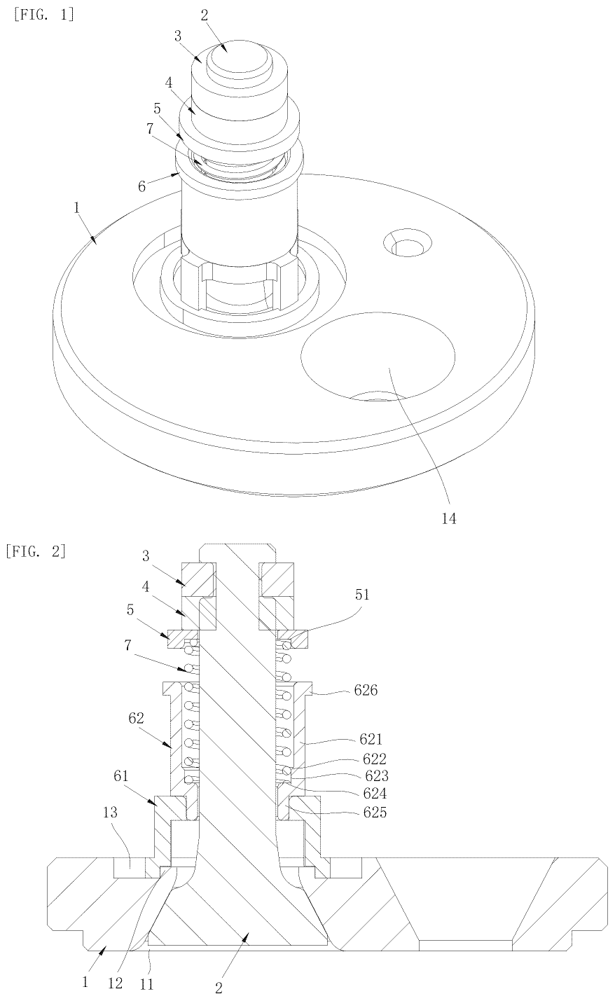

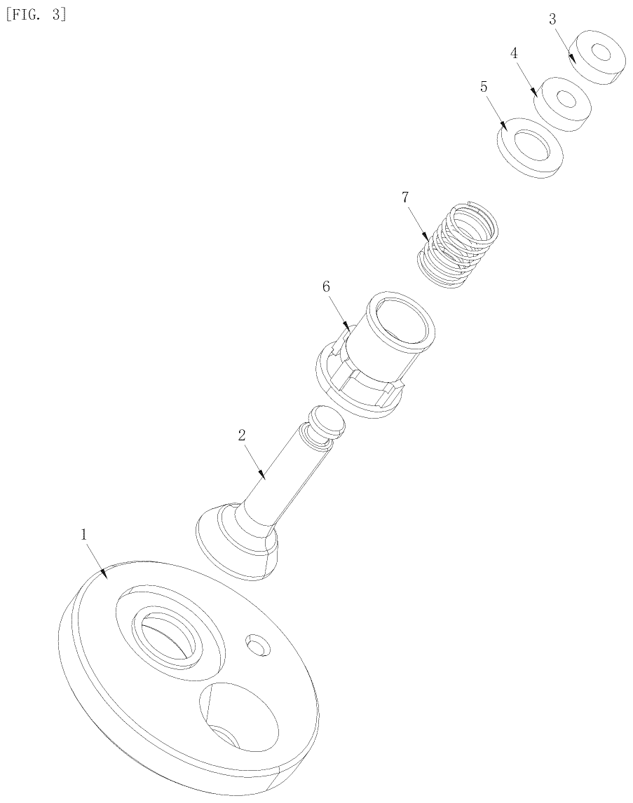

Referring to FIG. 2, in this embodiment, the side of the top ring 5 facing to the valve seat 1 is provided with a limiting groove 51, and one end of the intake spring 7 is fit with the limiting groove 51. The limiting groove 51 limits the radial displacement of the intake spring 7. Usually, the limiting groove 51 is in slightly close fit with the intake spring 7. The limiting groove 51 is rounded to make it easy for the intake spring 7 to enter the limiting groove 51. The depth of the limiting groove 51 is slightly greater than the wire diameter of the intake spring 7.

Referring to FIG. 2 to FIG. 7, in this embodiment, an inclined guide surface 622, a limiting portion 623 and a supporting portion 624 are further formed on an inner side of the intake protection assembly 6. The intake spring 7 abuts against the supporting portion 624. The limiting portion 623 limits a radial direction of the intake spring 7. Usually, the limiting portion 623 is in slightly close fit with the intake spring 7. The height of the limiting portion 623 is slightly larger than the wire diameter of the intake spring 7.

Referring to FIG. 2, in this embodiment, a radial gap between the intake annular wall 621 and the intake spring 7 is smaller than a radial gap between the intake spring 7 and the intake valve core 2, thus avoiding or reducing the friction between the intake spring 7 and the intake valve core 2.

Referring to FIG. 2, in this embodiment, projections of a lower end of the top ring 5 and an upper end of the intake protection assembly 6 in an axial direction at least partially overlap. The compression degree of the intake spring 7 is maximum when the intake annular wall 621 comes into contact with the top ring 5. An upper end of the intake annular wall 621 radially extends outward to form a convex ring 626. By limiting the maximum stroke of the intake valve core 2 through the top ring 5 and the intake protection assembly 6, the maximum compression degree of the intake spring 7 is limited, thus improving the service life of the intake spring 7. The convex ring 626 increases the contact area between the intake protection assembly 6 and the top ring 5.

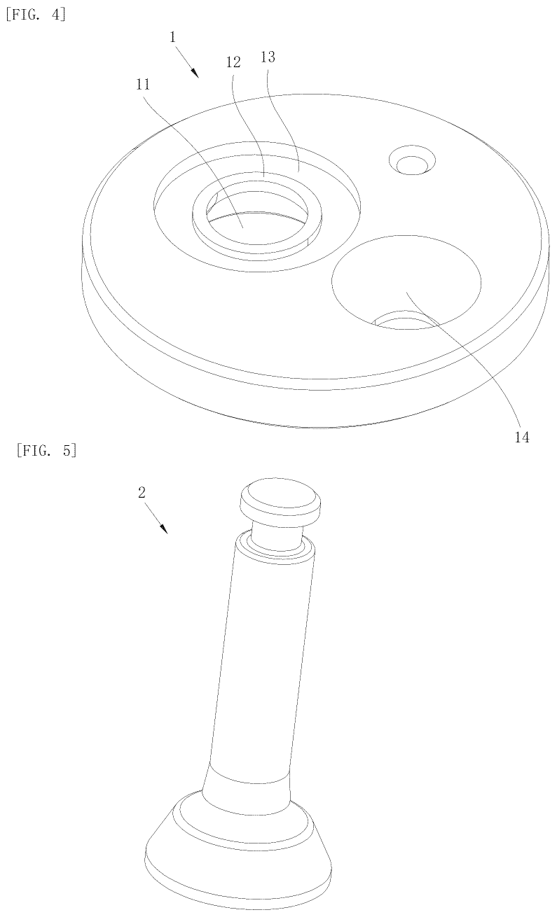

Referring to FIG. 2, FIG. 4 and FIG. 6 to FIG. 8, in this embodiment, the intake protection assembly 6 includes a bracket 61 and a spring seat 62 which are fixedly connected with each other. The bracket 61 is fixed on the valve seat 1. The intake annular wall 621 is formed on the spring seat 62. The bracket 61 is hollowed out to form the intake passage. The intake protection assembly 6 is assembled from a bracket 61 and a spring seat 62, so that it is relatively easy to manufacture. In other embodiments, the intake protection assembly may also be a single piece.

In this embodiment, the bracket 61 includes a first annular portion 611, a second annular portion 612, and a plurality of column portions 613 between the two. The intake passage is formed between the plurality of column portions 613.

In this embodiment, an annular convex portion 12 is formed at the intake hole 11 of the valve seat 1. The first annular portion 611 sleeves the annular convex portion 12. The diameter of an outer circle formed by the plurality of column portions 613 is smaller than that of the first annular portion 611 to form a step. An annular groove 13 is further formed outside the annular convex portion 12 of the valve seat 1. The height of the first annular portion 611 is adapted to the depth of the annular groove 13.

In this embodiment, a lower end of the spring seat 62 forms the intake guide portion 625. The intake guide portion 625 is inserted into the second annular portion 612. The intake guide portion 625 is in clearance fit with the intake valve core 2. The second annular portion 612 supports the spring seat 62.

Referring to FIG. 2 and FIG. 5, the intake valve core 2 is provided with a conical portion, a columnar portion and a transition portion fit with the intake hole 11 of the valve seat 1. A mounting groove is provided in the columnar portion.

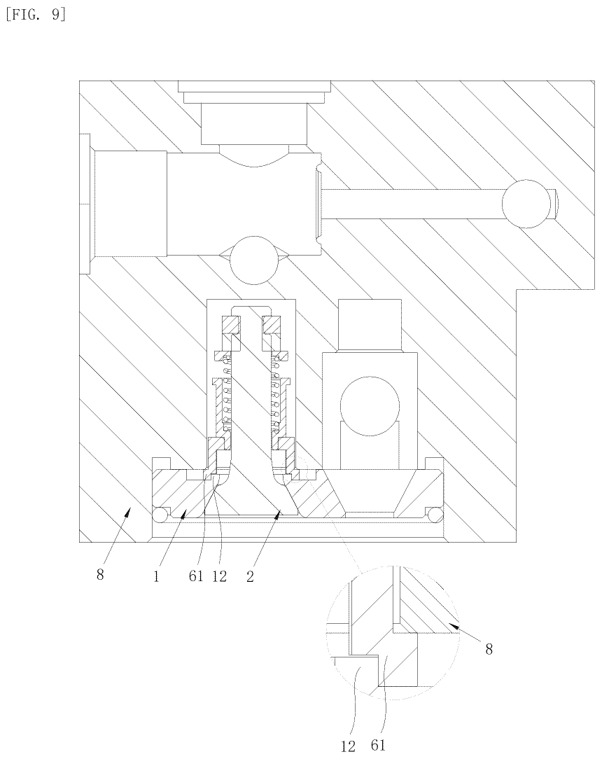

Referring to FIG. 9, the ventilation structure is used on a compressor. The compressor includes a cylinder body (not shown) and a cylinder head 8. The cylinder body and the cylinder head are fixedly connected. The cylinder body abuts against the valve seat 1. The cylinder body and the cylinder head fix the valve seat 1 and the bracket 61 to prevent the bracket 61 from being deflected. When the valve seat 1 is fixed, there is an axial gap between the column portions 613 of the bracket 61 and the annular convex portion 12 of the valve seat 1. An airflow passage is formed in cylinder head 8.

In this embodiment, the intake spring 7 is a cylindrical spring. Due to the arrangement of the intake protection assembly 6, the spring seat 62 of the intake protection assembly 6 is higher, and the position of the entire spring seat 62 corresponds to the columnar portion of the intake valve core 2. Therefore, a cylindrical spring can be used. Compared to the conical coil spring, the cylindrical spring (circular cross-section cylindrical spiral intake spring) has smaller radial deflection, linear characteristic line, stable stiffness and simple structure, and is easy to manufacture.

In this embodiment by providing, the intake protection assembly 6 with the intake annular wall 621 and providing the intake passage in the region between the intake spring 7 and the valve seat 1, the airflow path completely or partially avoids the intake spring 7, thus preventing the intake spring 7 from being impacted by the liquid refrigerant.

The intake structure of the ventilation structure of the refrigerant recovery machine according to embodiment 1 of the present utility model has the following beneficial effects: the intake protection assembly 6 is provided, the intake protection assembly 6 is provided with the intake annular wall 621 surrounding the lower part of the intake spring 7, and the intake annular wall 621 avoids or reduces the impact of the liquid refrigerant on the spring, thus reducing the risk of failure of the intake spring 7; the intake protection assembly 6 limits the maximum compression degree of the intake spring 7, thus improving the service life of the intake spring 7; the intake spring 7 is a cylindrical spring, which has small radial deflection; the radial intake passage formed between the plurality of column portions 613 of the bracket 61 of the intake protection assembly 6 avoids or reduces the airflow passing through the intake spring 7, thus avoiding or reducing the impact on the intake spring 7, and the compression degree of the intake spring 7 does not affect the intake volume; the radial displacement at two ends of the intake spring 7 is limited through the top ring 5 and the spring seat 62; even if the intake spring 7 fails, due to the arrangement of the intake guide portion 625 of the spring seat 62, the intake valve core 2 will hardly be deflected, thus avoiding or reducing the impact between the intake valve core 2 and the valve seat 1; the intake path is shorter.

In other embodiments, the intake structure may also adopt the following form: the inner diameter of the annular wall of the spring seat is made larger than the outer diameter of the top ring, the first elastic member and the second elastic member, and the height of the annular wall is increased, so that the top ring, the first elastic member and the second elastic member can enter the spring seat, thus further avoiding or reducing the impact of the liquid refrigerant on the compression spring. In this case, the limiting effect of the spring seat and the top ring on the stroke of the compression spring disappears.

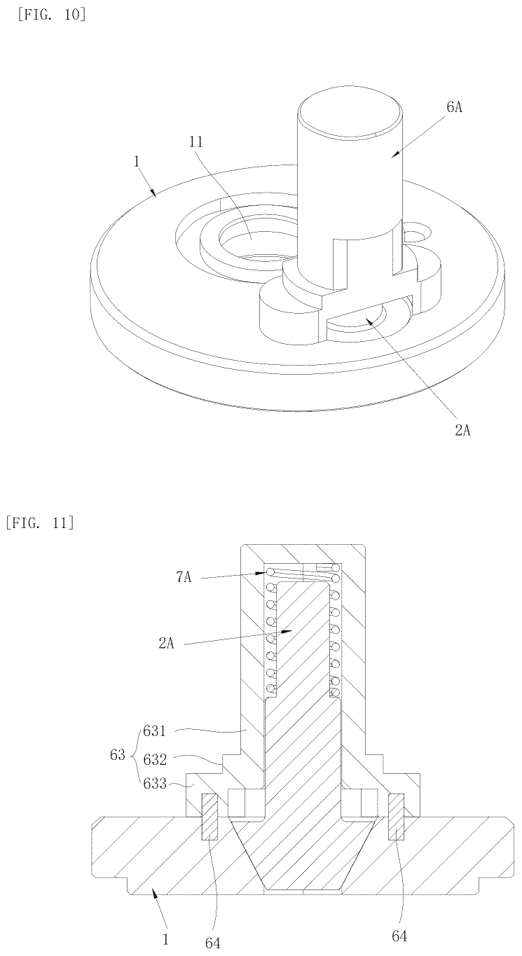

Referring to FIG. 10 to FIG. 14, the exhaust structure of the ventilation structure of the refrigerant recovery machine according to embodiment 1 of the present utility model includes:
the valve seat 1 provided with an exhaust hole 14;
an exhaust valve core 2A axially movable relative to the exhaust hole 14;
an exhaust protection assembly 6A provided on the valve seat 1 and provided with an exhaust guide portion for guiding the exhaust valve core 2A; and
an exhaust spring 7A sleeving the exhaust valve core 2A and respectively abutting against the exhaust protection assembly 6A and the exhaust valve core 2A,
wherein the exhaust protection assembly 6A is provided with an exhaust guide portion for guiding the exhaust valve seat 2A;
the exhaust protection assembly 6A is provided with an exhaust annular wall, and the exhaust annular wall surrounds the exhaust spring 7A.

In this embodiment, the exhaust protection assembly 6A includes an exhaust protection sleeve 63 and locating pins 64. The exhaust protection sleeve 63 is fixed to the valve seat 1 through the locating pins 64. The exhaust passage is formed in the end of the exhaust protection sleeve 63 close to the exhaust hole 14.

In this embodiment, the exhaust protection sleeve 63 is provided with a cylindrical portion 631, a reinforcement portion 632 and opening portions 633. One end of the exhaust spring 7A abuts against the cylindrical portion 631. The cylindrical portion 631 forms the exhaust annular wall. The number of the opening portions 633 is two. The number of the locating pins 64 is two.

In this embodiment, the exhaust valve core 2A includes a circular truncated cone portion and a stepped shaft portion located in the exhaust hole 14. The stepped shaft portion has a large diameter section and a small diameter section. The exhaust spring 7A sleeves the small diameter section and abuts against the large diameter section. The cylindrical portion 631 guides the large diameter section of the stepped shaft portion.

In this embodiment, the same valve seat 1 of the ventilation structure is provided with the intake hole 11 and the exhaust hole 14.

The exhaust structure of the ventilation structure of the refrigerant recovery machine according to embodiment 1 of the present utility model has the following beneficial effects: the exhaust protection assembly 6A guides the exhaust valve core 2A; the exhaust protection assembly 6A provides protection for the exhaust spring 7A, thus preventing the entire exhaust spring 7A from being impacted by the liquid refrigerant, preventing the exhaust spring 7A from being easily damaged and prolonging the service life; the exhaust protection assembly 6A wraps the exhaust spring 7A inside, thus providing a good protection effect; the exhaust passage is formed in the end of the exhaust protection assembly 6A close to the valve seat 1; the exhaust protection assembly 6A is mounted on the valve seat 1, thus more easily ensuring the coaxiality of the exhaust valve core 2A and the exhaust protection sleeve 63 of the exhaust protection assembly 6A, and guaranteeing the guiding effect.

What are described above are only specific embodiments of the present utility model, but the scope of protection of the present utility model is not limited thereto. Those skilled in the art should understand that the present utility model includes but is not limited to the content described in the specific embodiments above. Any modifications that do not deviate from the functional and structural principles of the present utility model should be included within the scope of the claims.

1. A ventilation structure of a refrigerant recovery machine, comprising:
a valve seat provided with an air hole;
a valve core axially movable relative to the air hole;
a compression spring mounted on the valve core: and
a protection assembly provided on the valve seat,
wherein the protection assembly is provided with an annular wall, the annular wall surrounds the compression spring, the compression spring is located at a distance from the valve seat, and a region of the protection assembly between the compression spring and the valve seat forms a radial ventilation passage.

2. The ventilation structure of the refrigerant recovery machine according to claim 1, wherein the protection assembly is provided with a guide portion for guiding a central part of the valve core, and the compression spring is further away from the air hole than the guide portion.

3. The ventilation structure of the refrigerant recovery machine according to claim 1, wherein the ventilation structure of the refrigerant recovery machine comprises an intake structure, and the intake structure comprises:
the valve seat provided with an intake hole;
an intake valve core axially movable relative to the intake hole;
an abutting assembly mounted at the end of the intake valve core away from the intake hole;
an intake protection assembly provided on the valve seat; and
an intake spring sleeving the intake valve core and respectively abutting against the intake protection assembly and the abutting assembly,
wherein the intake protection assembly is provided with an intake annular wall, the intake annular wall surrounds the intake spring, the intake spring is located at a distance from the valve seat, and a region of the intake protection assembly between the intake spring and the valve seat forms an intake passage.

4. The ventilation structure of the refrigerant recovery machine according to claim 3, wherein projections of the abutting assembly and the intake protection assembly in an axial direction at least partially overlap to limit the compression degree of the intake spring;
the side of the abutting assembly facing to the valve seat is provided with a limiting groove, and one end of the intake spring is fit with the limiting groove.

5. The ventilation structure of the refrigerant recovery machine according to claim 3, wherein the intake protection assembly is further formed with an inclined guide surface, a limiting portion, a supporting portion and an intake guide portion for guiding the intake valve core, the intake spring abuts against the supporting portion, and the limiting portion limits a radial direction of the intake spring;
a radial gap between the intake annular wall and the intake spring is smaller than a radial gap between the intake spring and the intake valve core;
an upper end of the intake annular wall radially extends outward to form a convex ring.

6. The ventilation structure of the refrigerant recovery machine according to claim 5, wherein the intake protection assembly comprises a bracket and a spring seat which are fixedly connected with each other, the bracket is mounted on the valve seat, the intake annular wall is formed on the spring seat, and the bracket is hollowed out to form the intake passage.

7. The ventilation structure of the refrigerant recovery machine according to claim 6, wherein the bracket comprises a first annular portion, a second annular portion, and a plurality of column portions between the two, the intake passage is formed between the plurality of column portions, an annular convex portion is formed at the intake hole of the valve seat, the first annular portion sleeves the annular convex portion, and the diameter of an outer circle formed by the plurality of column portions is smaller than that of the first annular portion to form a step;
the annular convex portion of the valve seat is further formed with an annular groove, and the height of the first annular portion is adapted to the depth of the annular groove.

8. The ventilation structure of the refrigerant recovery machine according to claim 7, wherein a lower end of the spring seat forms the intake guide portion, the intake guide portion is inserted into the second annular portion, the intake guide portion is in clearance fit with the intake valve core, and the second annular portion supports the spring seat;
the intake spring is a cylindrical spring;
the abutting assembly comprises a first elastic member, a second elastic member and a top ring, and the top ring is provided with the limiting groove.

9. The ventilation structure of the refrigerant recovery machine according to claim 1, wherein the ventilation structure of the refrigerant recovery machine comprises an exhaust structure, and the exhaust structure comprises:
the valve seat provided with an exhaust hole;
an exhaust valve core axially movable relative to the exhaust hole;
an exhaust protection assembly provided on the valve seat and provided with an exhaust guide portion for guiding the exhaust valve core; and
an exhaust spring provided on the exhaust valve core and respectively abutting against the exhaust protection assembly and the exhaust valve core,
wherein the exhaust protection assembly is provided with an exhaust annular wall, the exhaust annular wall surrounds the exhaust spring, the exhaust spring is located at a distance from the valve seat, and a region of the exhaust protection assembly between the exhaust spring and the valve seat forms an exhaust passage.

10. The ventilation structure of the refrigerant recovery machine according to claim 9, wherein the exhaust protection assembly comprises an exhaust protection sleeve and a locating pin, the exhaust protection sleeve is fixed to the valve seat through the locating pin, and the end of the exhaust protection sleeve close to the exhaust hole is hollowed out to form the exhaust passage;
the exhaust protection sleeve is provided with a cylindrical portion, a reinforcement portion and an opening portion, one end of the exhaust spring abuts against the cylindrical portion, and the cylindrical portion forms the exhaust annular wall; the cylindrical portion is in clearance fit with the exhaust valve core.
